(19) United States
(12) Patent Application Publication
(10) Pub. No.: US 2003/0126277 A1
(43) Pub. Date: Jul. 3, 2003

(54) Apparatus and method for providing multimedia streaming service by using point-to-point connection

(76) Inventors: Young Sung Son, Daejeon (KR); Heejeong Kim, Daejeon (KR); Kyeong Deok Moon, Daejeon (KR)

Correspondence Address: JACOBSON HOLMAN PLLC, 400 SEVENTH STREET N.W., SUITE 600, WASHINGTON, DC, 20004, US

(21) Appl. No.: 10/214,612

(22) Filed: Aug. 9, 2002

(30) Foreign Application Priority Data
Dec. 28, 2001 (KR) 2001-86984

(51) Int. Cl. G06F 15/16

(52) U.S. Cl. 709/231

(57) ABSTRACT

An apparatus for providing a multimedia streaming service by using a P2P approach includes a number of clients that distribute and store multimedia data and a number of servers that manage a multimedia data catalog listing data distributed and stored in the clients. The client, first, searches for multimedia data to be played stored in its local disk, and if there is no corresponding multimedia data in the local disk, the client calls for the multimedia data catalog to the server. The client searches for the corresponding multimedia data in the multimedia data catalog, and receives data from a client that stores the corresponding multimedia data. In case no clients store the corresponding multimedia data, he tries to receive data from the server.

### FIELD OF THE INVENTION

The present invention relates to a method for providing a VOD service, and more particularly, relates to a method for supporting a streaming service between servers and clients by using P2P (Peer-to-Peer) data transmission method.

### BACKGROUND OF THE INVENTION

A streaming is a technology that uses a network and a CPU resource optimally by transmitting, receiving and decoding a continuous media such as a large volume of a video and an audio in real time. In general, data whose entire volume is used up (for example, a compressed file: ZIP), generate an instantaneous load since all data are processed by downloading them from the server. However, in comparison with such data, because the continuous media requires a relatively small network bandwidth and a CPU load instantaneously it has a characteristic that the server has to process only necessary data over time. Generally, in order to apply the streaming technology to data transmission, it is necessary that the streaming be given a first priority in allocating a network bandwidth and a CPU load. However, since the Ethernet method widely used in the Internet cannot allocate a fixed network resource to the streaming, the data transmission may be delayed depending on a network condition. To solve this problem, in a conventional streaming technology, a method of maintaining a buffer, which can store the data during certain time (e.g., a few second), in a client system has been used.

FIG. 2 shows a method for managing the streaming by dividing a client's local memory buffer 221 into 3 portions.

This method transmits a certain quantity of data per unit time in the server 210, and makes client 220 prepare data needed for a decoding by maintaining sufficient data in the local memory buffer 221. If the local memory buffer 221 has data less than Lb, the client 220 requests for the server 210 to transmit more data than now, and the server 210 transmits more data (δ) per unit time than the previous time. Also, if the buffer 221 has data more than Ub, the client 220 requests for the server 210 to transmit less data than now, and the server 210 transmits less data (δ) per unit time than the previous time. If the data in the buffer 221 are depleted, the client 220 stops the decoding for a while, and restarts to play after filling the buffer 221 with data transmitted from the server 210. Such a phenomenon is called a jitter. If a network between the server 210 and the client 220 is unstable or if a congestion occurs when the client 220 tries to connect to the server 210, the jitter phenomenon frequently occurs.

As shown in FIG. 1, a bandwidth of networks 105 and 107 connecting end-users is relatively high thanks to a high speed network, but, because of a bandwidth limit of an intermediate network 104 that connects ISPs 101 and the users 106, a phenomena of instantaneously being unable to provide the streaming service may occur.

In the conventional Client-Server structure, roles of a server and a client are fixed, and there is a network connecting the server and the client. In general, a network bandwidth provided by the server is large and fixed. In order to prevent a congestion generated when the client calls for multimedia data, the number of users who are able to connect concurrently to the server is limited.

But, in the P2P structure, a network condition of each client is not fixed, and a work load condition of the client also is not stable. In particular, since a general home PC has no domain and no fixed IP, whenever each client using the PC connects to the Internet, an initialization of new network condition is needed. Also, there is a problem that the client has to consider the case that a counterpart client system is shutdown due to a user's voluntary action or mistake. Considering these features, a P2P architecture using a hybrid approach that partly depends on a control of a server is more preferred than those using complete connections between clients.

Because of these features, the P2P architecture may be inappropriate to be applied to the streaming service, and, also, has a problem that a reliability of a service provided by using the P2P architecture may be degraded. Therefore, current services provided by using the P2P architecture are usually confined to be used in an unreliable data service such as an Internet messenger, a file sharing program etc.

### SUMMARY OF THE INVENTION

It is, therefore, an object of the present invention to provide a method for executing a streaming service of multimedia data, wherein, once data of a server are transmitted to a client, the corresponding client becomes a temporary server in a client group including the client.

In accordance with one aspect of the invention, there is provided a multimedia streaming apparatus including: a server that stores multimedia data and/or a multimedia data catalog; and at least one client for playing multimedia data, wherein the client receives multimedia data by using a P2P (Peer-To-Peer) method.

In accordance with another aspect of the invention, there is provided a method for providing a multimedia streaming service by using a server and at least one client, the method including: a first step in which the client searches for multimedia data to be played in its own local disk; a second step in which, in case the multimedia data is not found in the local disk, a multimedia data catalog is requested from the server and received by the client; a third step in which, if the received multimedia data catalog has information on a client storing the multimedia data, the multimedia data is requested from to the client storing the multimedia data and received by the client, otherwise, the multimedia data is requested from the server and received by the client; and a fourth step in which the multimedia data is played.

### BRIEF DESCRIPTION OF THE DRAWINGS

The above and other objects and features of the present invention will become apparent from the following description of preferred embodiments given in conjunction with the accompanying drawings.

FIG. 1 is a diagram showing a conventional client-server system that provides a multimedia streaming service.

FIG. 2 shows a block diagram depicting a conventional client system that provides a multimedia streaming service.

FIG. 3 illustrates a diagram depicting a system where a method for providing a multimedia streaming service by using a P2P approach in accordance with the present invention is used.

FIG. 4 offers a multimedia data catalog table of a server in accordance with the present invention.

FIG. 5 describes a flow chart representing a procedure of a server that uses a method for providing a multimedia streaming service in accordance with the present invention.

FIG. 6 provides a flow chart describing a procedure of a client that uses a method for providing a multimedia streaming service in accordance with the present invention.

### DETAILED DESCRIPTION OF THE PREFERRED EMBODIMENTS

According to the present invention, video data is initially stored in a server, but once a client receives the video data, it is stored temporarily in a local disk of the client to be used later. And a video data catalog, which includes a list of video data to be reused, is transmitted to the server and maintained therein. The server arranges and manages the video data catalog listing video data received from a plurality of clients, and provides one of the video data to a client upon receipt of a request of the client.

In the following, configurations of a video server, a client and an operating method in accordance with the present invention are explained in detail with reference to the accompanying drawings.

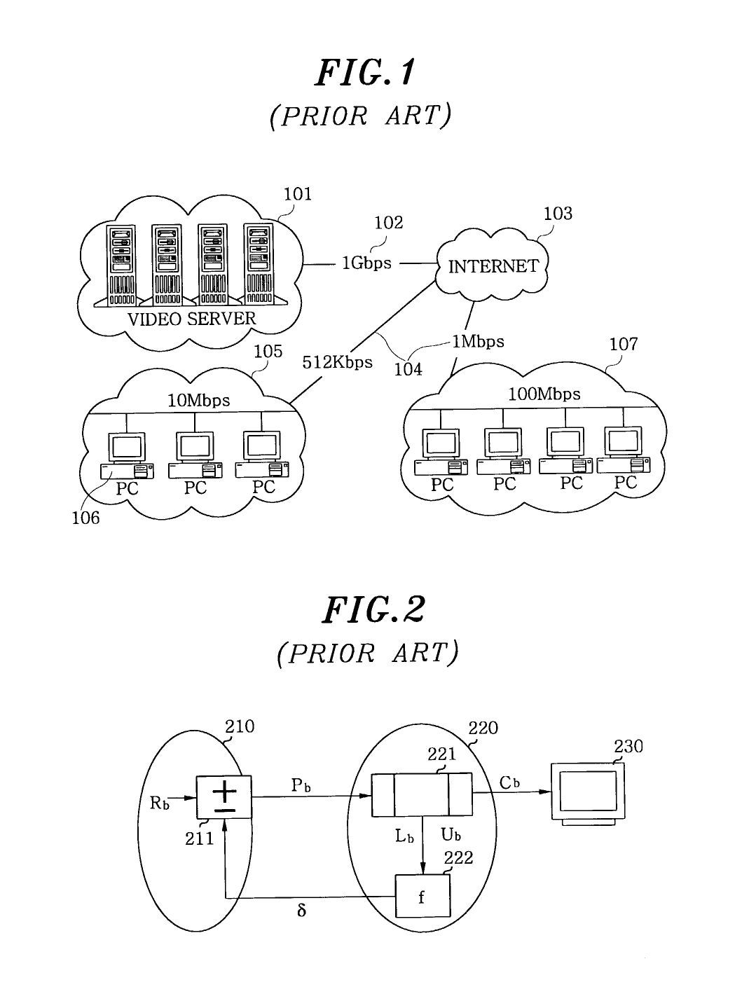

FIG. 1 shows a configuration where video data servers and clients provide a streaming service by using a P2P method in accordance with the present invention. Herein, the video data is of a file type such as MPEG, AVI and ASF. In general, because a volume of the video data is very large, each of the clients receives only a part of data that can be played for a short period of time, instead of receiving the whole video data for playing the video data.

In order to provide a video streaming service, there are needed video server 101 that stores the video data and, if necessary, transmits the stored video data, and clients 106 that play the video data received from one of the video servers through a monitor. Further, in general, the video servers 101 comprise a video server group, and the clients comprise a client group 105. This client group includes a local network of a high bandwidth. Between the server group and the client group, there are the Internet and access networks 102, 104 that make these groups cooperated with each other. In general, because the bandwidth of the Internet and the access networks is small in comparison with that of the local network connecting the server group and the client group, a bottleneck phenomenon may occur.

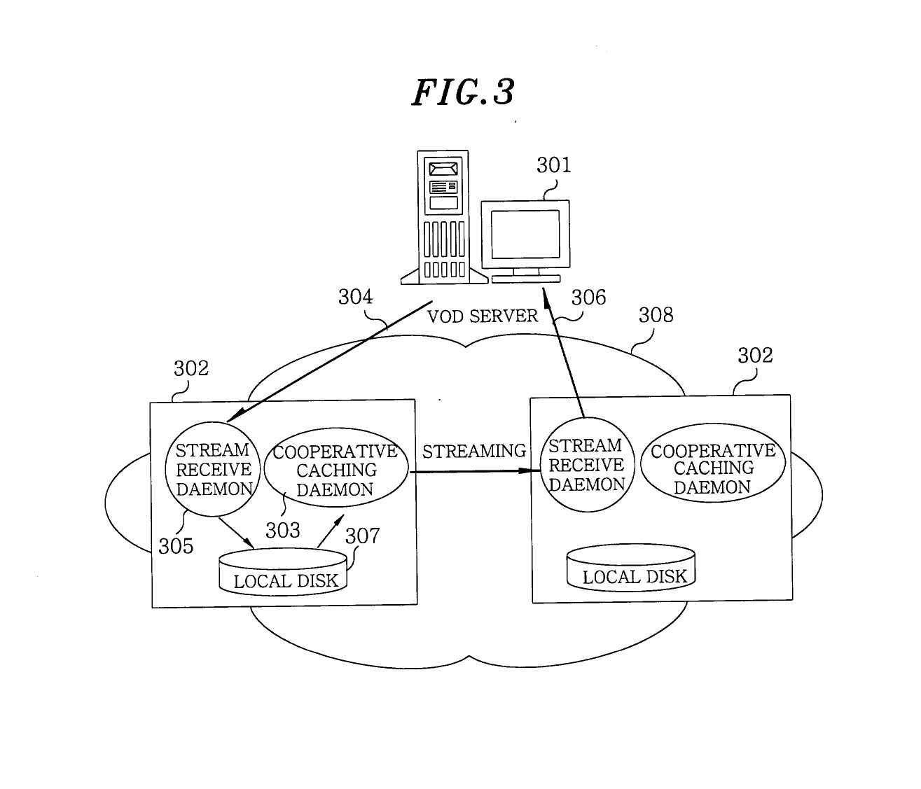

FIG. 2 offers a method for transmitting the video data to one of the clients 106 from one of the video servers 101. There are a Client-Pull model and a Server-Push model in a basic VOD service protocol. In the Server-Push model, data is transmitted from a server to a client through a constant data transmission rate without an information communication between the client and the server. In this case, since the server does not know a condition of the client part, a buffer overflow or a buffer underflow phenomenon can happen at the client part.

To prevent these phenomena, a feedback structure as shown in FIG. 2 is used. That is to say, if a local memory buffer 221 is short of data, a flag 222 indicates that the buffer 221 is not full of data. And then, this condition of the flag 222 is fed back to a server 210, so that the server 210 transmits more data per unit time than the previous time. Also, if the buffer 221 is full of data, the flag 222 indicates that the buffer 221 is full of data. Thereafter, this condition of the flag 222 is fed back to the server 210, so that the server 210 transmits less data per unit time than the previous time.

Meanwhile, in the Client-Pull model, a client requests data to a server on an on-demand basis. Since, in this architecture, the client can control the data transmission rate, a stable VOD service can be embodied. However, a control message is frequently transmitted between the client and the server, the server should execute a service scheduling, which results in an overhead.

FIG. 3 shows a system structure that provides a video streaming service by using a P2P method in accordance with the present invention.

The client 302 includes a streaming receive daemon 305 and a cooperative caching daemon 303. When a first client 302 wants to receive video data, the first client investigates whether one of clients included in a client group where the first client belongs to, stores the video data by communicating with the server 301. If one of the clients does not store the video data, the first client receives the video data from the server 301. Otherwise, the first client calls for a transmission of the data to the cooperative caching daemon 303 of a second client which stores the video data, and the streaming receive daemon 305 of the first client receives the video data from the second client.

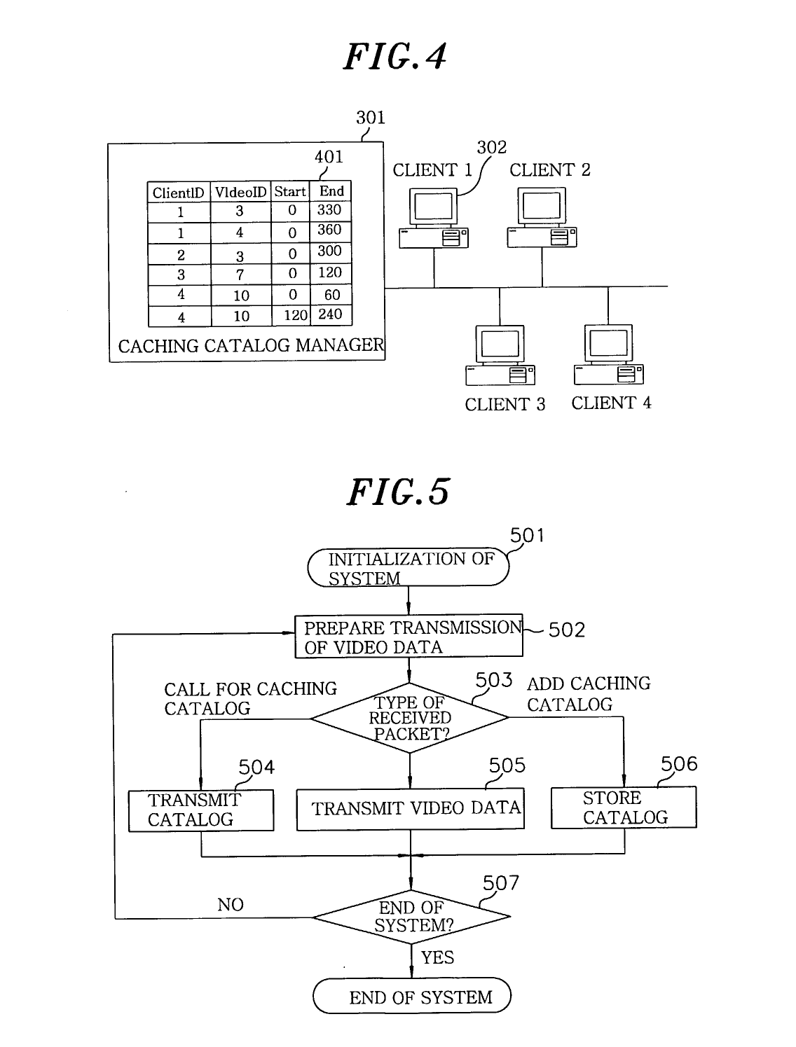

When each client 302 receives the video data, it stores temporarily the received video data to its own local disk 307, and transmits its video data catalog to the server 301. FIG. 4 shows a configuration of the video data catalog managed by the server 301.

The video server 301 manages the video catalog received from each client 302 by storing it in a caching catalog manager 401. This catalog is retrieved and used when another client calls for the catalog. As shown in FIG. 4, the catalog includes a ClientID for a client which stores video data, a VideoID for video data which the client stores, a start position and an end position of the video data that each client stores.

FIG. 5 shows a procedure executed by a server providing a streaming service by using a P2P method in accordance with the present invention.

First, the server initializes its system (step 501), and prepares for a transmission of video data (step 502). And then, the server investigates a content of a packet received from a client (step 503). If the packet is intended for requesting a caching catalog to the server, the catalog stored in the server is transmitted to the client (step 504). If the received packet is intended for requesting a transmission of video data to the server, the corresponding video data is transmitted to the client (step 505). If the received packet is a request for adding a caching catalog to the server, the corresponding catalog is stored in the server (step 506). Except the case the server terminates its system, the server prepares for a next transmission of video data after executing the above-described steps.

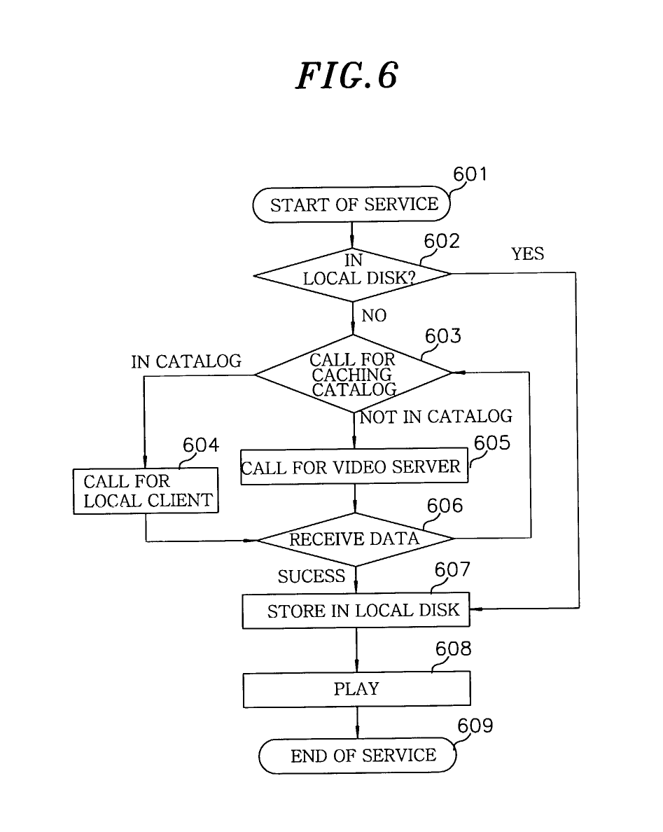

FIG. 6 shows a procedure performed by a client providing a streaming service by using a P2P method in accordance with the present invention.

First, the client begins a video play service (step 601), and investigates whether video data to be played is stored in its local disk (step 602). If the video data is stored in its local disk, the client plays the corresponding video data (step 607), and terminates the service (step 609). Otherwise, i.e., if the video data is not stored therein, the client calls for video data catalog to a server, and investigates whether information on the corresponding video data is in the catalog (step 603). If there is information on the corresponding video data in the catalog, it calls for a transmission of the corresponding video data to a client where the corresponding video data is stored (step 604). Otherwise, it calls for a transmission of the corresponding video data to the server (step 605). Next, the client receives the corresponding video data (step 606), and stores it in its local disk (step 607). The client plays the corresponding video data stored in its local disk (step 608), and terminates the service (step 609).

As described in the above, according to the present invention, effects of alleviating a bottleneck phenomenon of a network bandwidth and a problem of server load occurring in a conventional server-client structure, enhancing an efficiency of the whole system, and increasing the number of the users who are able to connect to a server, can be acquired by providing a streaming service using a P2P method in the server-client structure.

While the invention has been shown and described with respect to the preferred embodiments, it will be understood by those skilled in the art that various changes and modifications may be made without departing from the spirit and the scope of the invention as defined in the following claims.

What is claimed is:

1. A multimedia streaming apparatus comprising:
a server that stores multimedia data and/or a multimedia data catalog; and
at least one client for playing multimedia data,
wherein the client receives multimedia data by using a P2P (Peer-To-Peer) method.

2. The apparatus of claim 1, wherein the multimedia data catalog includes information on multimedia data stored in the client.

3. The apparatus of claim 2, wherein the client searches for information on multimedia data to be played by using the multimedia data catalog, and if the multimedia data to be played is not found in the multimedia data catalog, the multimedia data is received from the server by the client, otherwise, the multimedia data is received from the client in which the multimedia data is stored.

4. A method for providing a multimedia streaming service by using a server and at least one client, the method comprising:
a first step in which the client searches for multimedia data to be played in its own local disk;
a second step in which, in case the multimedia data is not found in the local disk, a multimedia data catalog is requested from the server and received by the client;
a third step in which, if the received multimedia data catalog has information on a client storing the multimedia data, the multimedia data is requested from to the client storing the multimedia data and received by the client, otherwise, the multimedia data is requested from the server and received by the client; and
a fourth step in which the multimedia data is played.
